(19) United States
(12) Patent Application Publication
(10) Pub. No.: US 2017/0166427 A1
(43) Pub. Date: Jun. 15, 2017

(54) Universal pinch weld protective adapter

(71) Applicant: Robert William Grace, Homosassa, FL (US)

(72) Inventor: Robert William Grace, Homosassa, FL (US)

(21) Appl. No.: 14/757,286

(22) Filed: Dec. 14, 2015

(51) Int. Cl. B66F 13/00

(52) U.S. Cl. CPC B66F 13/00

(57) ABSTRACT

A universal pinch weld protective adapter is used with automotive floor jacks and inground hydraulic lifts to safely raise unibody vehicles. The invention protects a unibody vehicle's pinch weld from damage when lifted using the invention. The invention is formed by welding pieces of steel square tubing to create a single embodiment. A protective layer of PVC covers the top of the embodiment and the beveled slot. A layer of nonskid rubber protects the surface of the lifting device that the invention is placed on and the bottom of the invention. The invention's beveled slot design makes it self-centering. The use of steel square tubing creates an invention specifically designed for heavy-duty use with lifting devices used to lift unibody vehicles.

### CROSS-REFERENCE TO RELATED APPLICATIONS

### U.S. Patent Documents

U.S. Pat. No. 5,860,491 January 1999 Fletcher

U.S. Pat. No. 4,241,900 December 1980 Okuda

### BACKGROUND

The field of endeavor to which the invention pertains is automotive floor jacks and inground hydraulic lifts and other lifting devices used for lifting unibody vehicles with a pinch weld located on the rocker panel and vehicles with a pinch weld.

The invention relates to inground hydraulic lifts and automotive floor jacks used for raising a vehicle to perform routine maintenance, such as a tire change, tire rotation, or the need to access the bottom of the vehicle for maintenance. This invention is designed to be used with automotive floor jacks and inground hydraulic lifts used in commercial settings, including auto repair shops, tire dealers, automobile dealership service bays, body shops, transmission repair shops et al. The invention is also for use by the “do-it-yourself” weekend mechanic, car enthusiast, collector, etc. The construction of unibody vehicles entails joining the sheet steel floor and sides which creates a pinch weld or seam which runs the length of the vehicle on both sides between the wheels, at the bottom of the rocker panel. Manufacturers designate a location on the bottom of the pinch weld, in close proximity to the wheel well, to indicate what, hereto for, will be referred to as a factory specified lift point. This is the location the vehicle may be raised from when lifting the vehicle (e.g. using a jack to change a flat tire).

Those who perform maintenance on their vehicles can use an automotive floor jack to raise the vehicle. The typical saddle on a floor jack creates metal on metal contact as it supports the weight of the vehicle along a short length of the thin pinch weld. Lifting the vehicle with a floor jack positioned directly under the pinch weld risks damaging the thin metal pinch weld. People report crushing, bending, splitting, cracking, and damaging the pinch weld when attempting to lift the vehicle with a standard floor jack positioned under the pinch weld. Such damage can be very difficult to repair. The floor jack places so much stress on the pinch weld it can also misalign body panels, especially when positioned close to the wheel well where the factory specified lift points are located. It should be noted that the factory specified lift points are sometimes not easily identified. Markings can be one or two small semicircle or V-shaped notches on the bottom edge of the pinch weld or a short rectangular notch on the bottom edge of the pinch weld. Sometimes the location of the factory specified lift points can only be found by referencing an illustration in the owner's manual showing an arrow pointing to the bottom of the vehicle. In commercial applications, the vehicle is lifted by the pinch weld which rests on the solid steel flat support arms of the inground hydraulic lifts used in most auto repair businesses, etc. Routinely the pinch weld is bent, crushed, or deformed by the inground hydraulic lift steel support arms. Both floor jacks and inground hydraulic lifts create metal on metal contact with the pinch weld. Those who perform maintenance on their vehicles sometimes resort to sawing a slot in a short length of 2×4 or 4×4 wood which is then positioned on the floor jack's saddle, which when raised, straddles the pinch weld. Ideally, the wood only comes in contact with the rocker panel as the pinch weld is positioned in the saw cut. People report the wood splitting under the weight of the vehicle creating a serious safety hazard. Others cut a slot in a hockey puck and position it on the floor jack's saddle to avoid damaging the pinch weld. Some commercial devices duplicate the hockey puck approach, but use other materials such as hard rubber, urethane, plastic, and other materials. Some devices' instructions include a warning: “Not suitable for SUVs, trucks, and vans” because of their weight.

The width of the pinch weld is not standardized across the broad spectrum of automobile manufacturers. The width of the pinch weld is measured from the top of the pinch weld, which is the point where the pinch weld joins the rocker panel, to the bottom edge of the pinch weld. The width of the pinch weld varies from one make and model to another. The pinch weld often varies in width from the front, to the middle, to the rear of the vehicle as well. The pinch weld seldom exceeds one eighth (0.125 inches) of an inch in thickness. Some devices have slots which are not deep enough to protect the pinch weld. Using such devices allows the bottom edge of the pinch weld to rest in the device's slot before the device's top surface makes contact with the rocker panel. This defeats the purpose of the device and greatly reduces the usefulness of such devices. Other commercial devices cut a narrow slot in steel square tubing which is then positioned on the floor jack saddle with a round stem which extends from the bottom of the device and fits into a hole in the center of the floor jack saddle. That requires the floor jack's saddle to have a round hole in the center sufficiently large enough to accept the stem. Some designs require the removal of the saddle to install a device with a stem. The floor jack saddle is not a removable part on some floor jacks.

The device design incorporating a round metal stem renders the device unusable with an inground hydraulic lift. Using other like purpose devices results in a metal or hard surface coming into contact with the rocker panel and the pinch weld itself which can scratch, gouge, crack, or compromise the factory-applied paint or coating on the rocker panel. Any compromise of the rocker panel surface on the bottom of the vehicle is prone to rust development. During the winter months many states use salt on the ice and snow-covered roads which is corrosive and will cause rust to form on bare metal resulting from a scratch or gouge, or compromise of the factory coating on the rocker panel. Over time such rust can eat through the rocker panel.

### SUMMARY

The invention, when used with a floor jack or inground hydraulic lift, ensures the safe lifting of a unibody vehicle without damaging the pinch weld or rocker panel. The invention is an embodiment formed by joining lengths of steel square tubing. The use of cold rolled steel square tubing and the design creates an invention capable of supporting a unibody vehicle weighing several tons or more with a significant margin of safety. A slot on the top of the invention is beveled. The beveled design makes the invention self-centering when placed on an inground hydraulic lift or floor jack used to lift a unibody vehicle by the pinch weld. The top of the invention and the slot is covered with high-density PVC which protects the rocker panel and the pinch weld when positioned to lift the vehicle and enhances the self-centering feature.

The bottom of the invention has a layer of industrial-grade rubber. The industrial-grade rubber is nonskid, protective of surfaces it's in contact with, and resistant to petroleum products.

The self-centering aspect of the beveled PVC-lined slot is another advancement in the art. The broad range of applications, from commercial to “do-it-yourself” backyard mechanics, gives it advantages over devices of like purpose. The invention serves the automobile dealer service technicians, the automotive repair shop mechanics, the tire dealer installers, the muffler shop mechanics, the transmission repair shop technicians and a host of others. The invention serves the “do-it-yourself” backyard mechanic, car enthusiast, collector, et al equally well. Those experienced in the art will appreciate the emphasis on safety, durability, and versatility spanning a wide range of users and applications.

### BRIEF DESCRIPTION OF THE SEVERAL VIEWS OF THE DRAWING

FIG. 1 is an elevated perspective view of the invention

FIG. 2 is a view of one end of the invention

FIG. 3 is a view of the other end of the invention (the ends are identical)

FIG. 4 is a view of one side of the invention

FIG. 5 is a view of the other side of the invention (the sides are identical)

FIG. 6 is a view of the top of the invention showing the beveled and horizontal surfaces of the slot

FIG. 7 is a view of the bottom of the invention

FIG. 8 is a longitudinal view, cross-section of a unibody rocker panel and pinch weld with the invention in contact with rocker panel. This is the view looking from the front wheel well to the rear wheel well.

FIG. 9 is a view perpendicular to the rocker panel and pinch weld showing the side view of the invention which is in contact with the rocker panel.

### DETAILED DESCRIPTION OF THE DRAWINGS

The invention 1 is constructed from steel square tubing. Three pieces of steel square tubing are joined together (welded) to form a single piece 1 of ASTM (American Society for Testing and Materials) A500 cold rolled steel, which is the invention. The ASTM A500 steel was used because it's a common cold rolled steel. It's the most common specification in North America. It's preferred when the quality of steel is an important factor. It has higher tensile strength and yield strength than hot rolled steel and is readily available. The A500 cold rolled steel has a maximum yield strength of over 40,000 PSI. Other grades of steel, aluminum, titanium, various composites, and other materials could also be used so long as they have the strength and rigidity to support the weight of a vehicle. The invention could also be fabricated by casting, machining, or fusing the pieces together with a variety of other industrial processes. The most important factor when lifting vehicles is safety. Everyone must always be safety conscious when using tools, machines, and all lifting devices. The use of cold rolled steel is a logical choice when safety is paramount. The invention 1 by design and material advances the art and creates a substantial margin of safety when lifting vehicles that weigh several tons or more.

Material was removed from the top of the invention 1 to create a beveled slot where the pinch weld is positioned when the invention is in contact with the rocker panel. The top of the invention is covered by high-density PVC (polyvinyl chloride) 2 which extends slightly down the sides as protection when handling the invention in close proximity to painted surfaces.

The layer 2 completely covers the top of the invention, 1, the beveled surfaces, and the vertical and horizontal sides of the slot protecting the pinch weld. The high-density PVC is a smooth-surfaced material 2 which will not scratch or rub the rocker panel surface or the pinch weld. Its flexibility allows it to compress slightly to accommodate imperfections in the rocker panel surface. Readily available, inexpensive, and easy to work with, the high-density PVC material 2 is bonded to the steel surface of the invention 1 with an industrial-grade adhesive. The high-density PVC material 2 is highly resistant to petroleum products routinely used in the garage environment. Other materials and bonding methods are suitable providing the surface is smooth so as to not scratch or rub the factory coating on the rocker panel, has sufficient flexibility to allow for some compression, and finally has properties that make it resistant to petroleum products. The top of the invention 1 is larger than other similar-purpose devices (e.g. those using the hockey puck style design). The increased surface area reduces the pounds per square inch load that is placed on the rocker panel by the partial weight of the vehicle. The combination of the high-density PVC smooth surface 2 and the beveled-opening slot design make the invention self-centering. This is a feature not found on other devices with similar function. If the invention is slightly misaligned with the pinch weld 4 as the invention 1 (which is positioned on the saddle of a floor jack or the steel support arm of an inground hydraulic lift) moves up to make contact with the rocker panel, the pinch weld contacts the slot's beveled side and in doing so moves the invention sufficiently so as to slightly realign the invention with the pinch weld as it enters the high-density PVC protected slot.

The distance from the top of the invention's slot to the high-density PVC protective layer 2 on the base of the slot is sufficient to protect any pinch weld regardless of how wide it is, while still leaving a small margin between the bottom edge of the pinch weld and the protective PVC layer 2 on the bottom of the invention's slot.

A layer of industrial-grade rubber 3 covers the bottom of the invention. This layer serves two purposes. It provides a nonskid surface which is imperative when placing the invention on the steel extension support arms of an inground hydraulic lift or the saddle of a floor jack. It also serves to protect the floor jack from scratches. This material is easy to work with, readily available, and very durable. It is also resistant to petroleum products used in the automotive garage environment. The industrial-grade rubber 3 has the same characteristics as drive belts used on automobile engines, such as timing belts. A commercial-grade adhesive bonds this material 3 to the bottom of the invention. The properties of the industrial-grade rubber allow it to compress ever so slightly enhancing the nonskid characteristic. Other materials and other methods of bonding them to the bottom of the invention are suitable if they are nonskid, durable, protective, and resistant to petroleum products used in the automotive garage environment. The industrial-grade rubber bottom of the invention ensures the invention remains in place when the invention is positioned on the inground hydraulic lift steel support arms. (For illustration purposes only, reference U.S. Pat. No. 5,860,491, January 1999, Fletcher, drawing on sheet 12 of 20, FIG. 16, showing the pivoting, adjustable steel support arms. No benefit is claimed) Using the invention on each of the four steel support arms allows the inground hydraulic lift to raise the vehicle without damaging the pinch weld or the rocker panel while keeping the vehicle level.

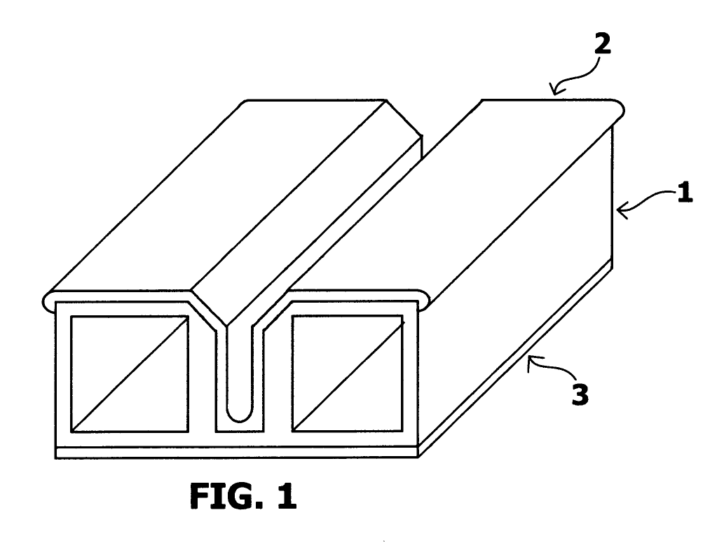

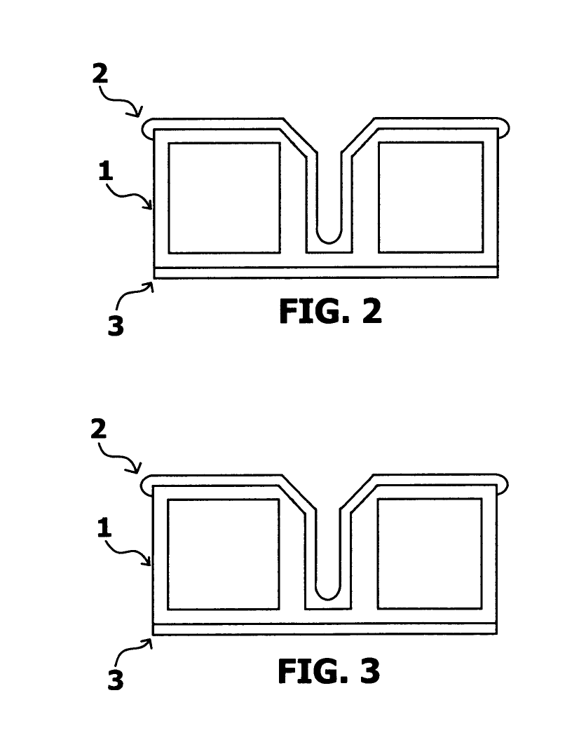

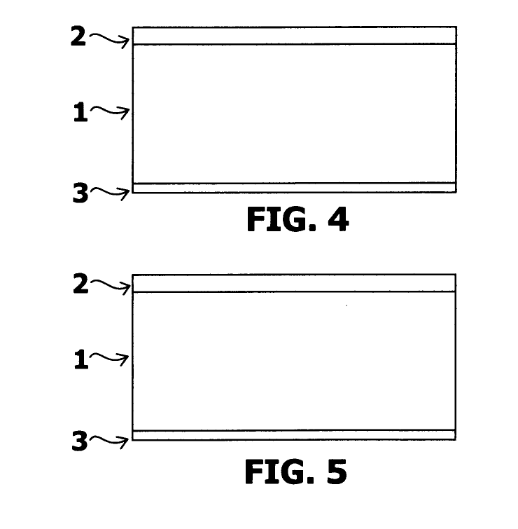

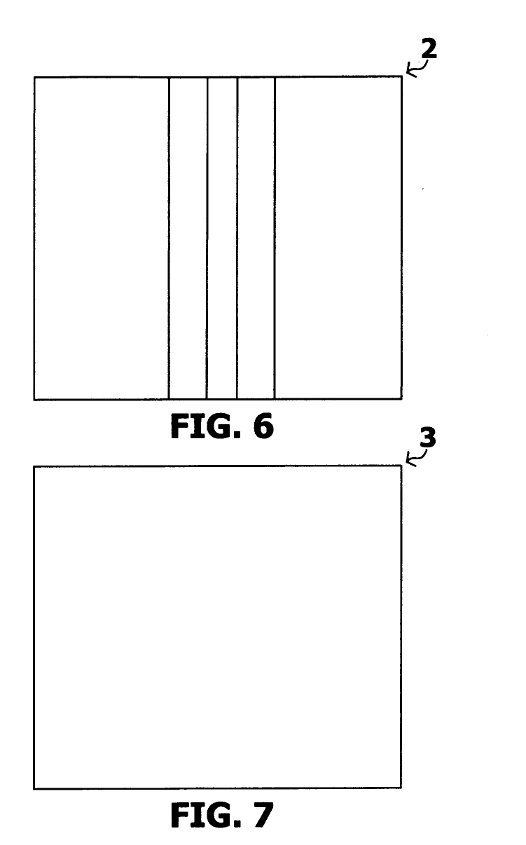

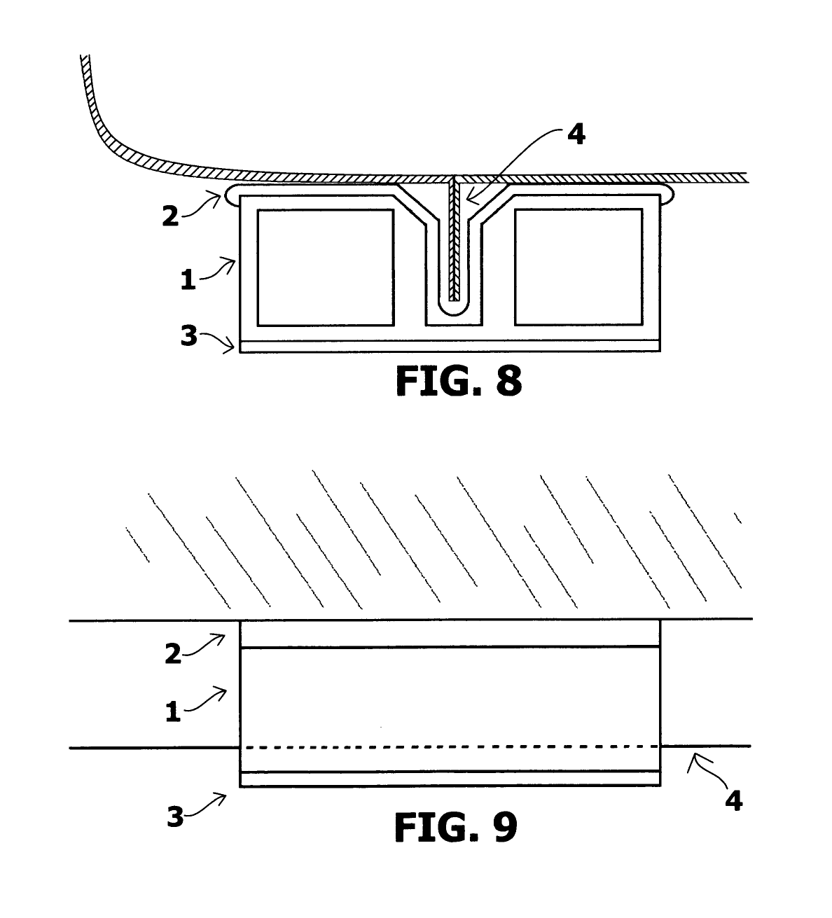

Heavy-duty floor jacks often used by “do-it-yourself” weekend mechanics are usually made of steel. Other floor jacks called “racing” jacks are made out of aluminum and are lighter and more expensive. They have finishes such as powder-coated finishes, chrome finishes, mirror finishes, clear coat finishes, and brushed aluminum finishes etc. The industrial-grade rubber bottom on the invention will not mar or scratch the finish on the racing jack's saddle. (For illustration purposes only, reference U.S. Pat. No. 4,241,900, December 1980, Okuda, drawing on sheet 1 of 2, FIG. 1, numeral 1, showing the saddle. No benefit is claimed) Those familiar with the art will appreciate how this invention advances the state-of-the-art.

To this point, the invention has been shown and described in what is considered to be the most practical and preferred embodiments. It is recognized, however, that departures may be made within the spirit and scope of the invention. A person skilled in the art will discern that obvious modifications will occur. With respect to the above description then, it is to be realized that the optimum dimensional and material characteristics of the invention, to include variations in size, materials, shape, form, function, manner of use, manufacture and assembly are deemed readily apparent and obvious to those skilled in the art, and all equivalent relationships to those illustrated in the drawings and described in the specification are intended to be encompassed by the present invention.

The invention claimed is:

1. The universal pinch weld protective adapter, which is the invention consisting of a single, slotted, rectangular steel structure comprised of three sections of steel square tubing with a beveled slot and a layer of high-density PVC covering the horizontal top of the invention, the beveled, vertical, and horizontal sides of the slot and a layer of industrial-grade rubber covering the bottom of the invention.
